(19) United States
(12) Patent Application Publication
(10) Pub. No.: US 2008/0176631 A1
(43) Pub. Date: Jul. 24, 2008

(54) GAMING MACHINE PROVIDING AN AWARD CORRESPONDING TO THE NUMBER OF PLAYED GAMES WITHIN A PREDETERMINED TIME LIMIT

(75) Inventor: Hiro SAKUMA, Tokyo (JP)

Correspondence Address: ARENT FOX LLP, 1050 CONNECTICUT AVENUE, N.W., SUITE 400, WASHINGTON, DC, 20036, US

(73) Assignee: Aruze Corp., Tokyo (JP)

(21) Appl. No.: 11/970,848

(22) Filed: Jan. 8, 2008

(30) Foreign Application Priority Data
Jan. 10, 2007 (JP) 2007-002710

(51) Int. Cl. A63F 9/24; A63F 13/00

(52) U.S. Cl. 463/20

(57) ABSTRACT

A gaming machine is provided, which includes a memory, an input device and a controller. The memory stores a number of played games and a predetermined time limit applied to the games. The input device accepts an operation to start a game. The controller is configured with logic to: (a) start the game when the input device has accepted the operation to start the game; (b) start counting up time at predetermined regular intervals to the time limit when a result of the game satisfies a predetermined condition; (c) increase the number of played games each time a game is started; and (d) when the number of played games is equal to or greater than a predetermined threshold at expiration of the time limit, pay a player in accordance with a predetermined award.

This application is based on and claims the benefit of priority from Japanese Patent Application No. 2007-002710, filed on 10 Jan. 2007, the content of which is incorporated herein by reference.

### BACKGROUND OF THE INVENTION

1. Field of the Invention

The present invention relates to a gaming machine which provides an award corresponding to the number of played games within a predetermined time limit.

2. Related Art

Conventionally, in regards slot machines, which are a type of gaming machine, a game is generally started by inserting a game medium such as coins into the gaming machine. Then, the slot machine displays an image of a symbol line which is rotated in a predetermined area of the gaming machine. After a predetermined amount of time elapses, the slot machine displays an image of the symbol line which is stopped. Finally, the slot machine provides an award to a player based on the combination of the stationary symbols. Whether a combination for which an award is provided has been formed or not is generally determined based on whether or not a predetermined number of the same type of symbols (for example, “Cherry”, “7”, etc.) is arranged along a predetermined active pay line. Furthermore, these slot machines have a game mode which can multiply payback to players. U.S. Pat. No. 7,052,392 discloses a technique that allows a player to improve the odds of winning in a bonus game associated with a result of a basic game.

### SUMMARY OF THE INVENTION

Although U.S. Pat. No. 7,052,392 discloses a technique that allows a player to improve the odds of winning in a bonus game associated with a result of a basic game, the entertainment properties of the technique thus disclosed has become ordinary of recent, and thus players have lost interest.

The present invention has an object of providing a gaming machine which can further improve entertainment properties.

In an aspect of the present invention, a gaming machine is provided, which includes a memory, an input device and a controller. The memory stores a number of played games and a predetermined time limit applied to the games. The input device accepts an operation to start a game. The controller is configured with logic to: (a) start the game when the input device has accepted the operation to start the game; (b) start counting up time at predetermined regular intervals to the time limit when a result of the game satisfies a predetermined condition; (c) increase the number of played games each time a game is started; and (d) when the number of played games is equal to or greater than a predetermined threshold at expiration of the time limit, pay a player in accordance with a predetermined award.

The gaming machine described above allows the player to be paid in accordance with the predetermined award when the player can play the games the predetermined number of times within the time limit.

Since the player can advantageously increase the number of games in a lost game that does not need time to pay out, the gaming machine gives a new dimension to the game.

In another aspect of the present invention, a gaming machine is provided, which includes a display device, a memory, an input device and a controller. The display device displays an image related to a game. The memory stores a number of played games and a predetermined time limit applied to the games. The input device accepts an operation to start a game. The controller is configured with logic to: (a) start the game when the input device has accepted the operation to start the game; (b) start counting up time at predetermined regular intervals to the time limit when a result of the game satisfies a predetermined condition; (c) increase the number of played games each time a game is started; (d) cause the display device to display an image of the counted time; and (e) when the number of played games is equal to or greater than a predetermined threshold at expiration of the time limit, pay a player in accordance with a predetermined award.

The gaming machine described above allows the player to visually comprehend the counted time, providing more fun to the player in playing the game.

In still another aspect of the present invention, a gaming machine is provided, which includes a display device, a memory, an input device and a controller. The display device displays an image related to a game. The memory stores a number of played games and a predetermined time limit applied to the games. The input device accepts an operation to start a game. The controller is configured with logic to: (a) start the game when the input device has accepted the operation to start the game; (b) start counting up time at predetermined regular intervals to the time limit when a result of the game satisfies a predetermined condition; (c) increase the number of played games each time a game is started; (d) cause the display device to display an image of the counted time and the number of played games; and (e) when the number of played games is equal to or greater than a predetermined threshold at expiration of the time limit, pay a player in accordance with a predetermined award.

The gaming machine described above allows the player to visually comprehend the counted time and the number of played games, providing more fun to the player in playing the game.

In yet another aspect of the present invention, a gaming machine is provided, which includes a memory, an input device and a controller. The memory stores a number of played games and a predetermined time limit applied to the games. The input device accepts an operation to start a game. The controller is configured with logic to: (a) start the game when the input device has accepted the operation to start the game; (b) start counting up time at predetermined regular intervals to the time limit when a result of the game satisfies a predetermined condition; (c) increase the number of played games each time a game is started; and (d) when the number of played games is equal to or greater than a predetermined threshold at expiration of the time limit, pay a player in accordance with the number of played games.

The gaming machine allows the player to advantageously increase the number of games in a lost game that does not need time to pay out. Since the player can obtain the award in accordance with the number of played games, the player feel more excited in playing the game.

In a further aspect of the present invention, a gaming machine is provided, which includes a display device, a memory, an input device and a controller. The display device displays an image related to a game. The memory stores a number of played games and a predetermined time limit applied to the games. The input device accepts an operation to start a game. The controller is configured with logic to: (a) start the game when the input device has accepted the operation to start the game; (b) start counting up time at predetermined regular intervals to the time limit when a result of the game satisfies a predetermined condition; (c) increase the number of played games each time a game is started; (d) cause the display device to display an image of the counted time; and (e) when the number of played games is equal to or greater than a predetermined threshold at expiration of the time limit, pay a player in accordance with the number of played games.

In a still further aspect of the present invention, a gaming machine is provided, which includes a display device, a memory, an input device and a controller. The display device displays an image related to a game. The memory stores a number of played games and a predetermined time limit applied to the games. The input device accepts an operation to start a game. The controller is configured with logic to: (a) start the game when the input device has accepted the operation to start the game; (b) start counting up time at predetermined regular intervals to the time limit when a result of the game satisfies a predetermined condition; (c) increase the number of played games each time a game is started; (d) cause the display device to display an image of the counted time and the number of played games; and (e) when the number of played games is equal to or greater than a predetermined threshold at expiration of the time limit, pay a player in accordance with the number of played games.

According to the present invention, a player can enjoy further entertainment properties.

### BRIEF DESCRIPTION OF THE DRAWINGS

FIG. 1 is a flowchart showing the flow of a game which is executed in a slot machine according to the preferred embodiment of the present invention;

FIG. 2 is an external perspective view showing the slot machine according to the preferred embodiment of the present invention;

FIG. 3 is an enlarged front view showing an enlarged view of a display region of the slot machine according to the preferred embodiment of the present invention;

FIG. 4 is a block diagram showing a controller of the slot machine according to the preferred embodiment of the present invention;

FIG. 5 is a block diagram showing a display/input controller of the slot machine according to the preferred embodiment of the present invention;

FIG. 6 is a diagram showing a symbol line represented on each video reel according to a preferred embodiment of the present invention;

FIG. 7 is a diagram showing a symbol arrangement table according to the preferred embodiment of the present invention;

FIG. 8 is a flowchart showing a main flow for a game program executed by the slot machine according to the preferred embodiment of the present invention;

FIG. 9 is a flowchart showing a flow for processing a basic game executed by the slot machine according to the preferred embodiment of the present invention;

FIG. 10 is a flowchart showing a flow for processing a basic game executed by the slot machine according to the preferred embodiment of the present invention;

FIG. 11 is a continued flowchart from FIG. 10.

FIG. 12 is a diagram showing a random number table for a basic game according to the preferred embodiment of the present invention;

FIG. 13 is a diagram showing a payout table for a basic game according to the preferred embodiment of the present invention;

FIG. 14 is a diagram showing a payout table for a sub game according to the preferred embodiment of the present invention; and

FIGS. 15 and 16 are examples of display images according to the preferred embodiment of the present invention.

### DETAILED DESCRIPTION OF THE INVENTION

The embodiments of the present invention are hereinafter described in detail with reference to the attached drawings.

The slot machine 13 according to the present invention is provided with RAM 110 storing the number of played games and a predetermined time limit in regards to the game, and a touch panel 32 accepting an input by a start operation in the game. A CPU 106 starts the game in response to the acceptance of the input by the start operation in the game by way of a start switch 25. When a predetermined condition is generated, the CPU 106 starts processing for incrementing by a certain number the number of the played games every time the game is started. Upon a predetermined time limit elapsing, in a case in which the number of the played games is more than the predetermined times of the games thus played, the CPU 106 provides an award according to a predetermined award.

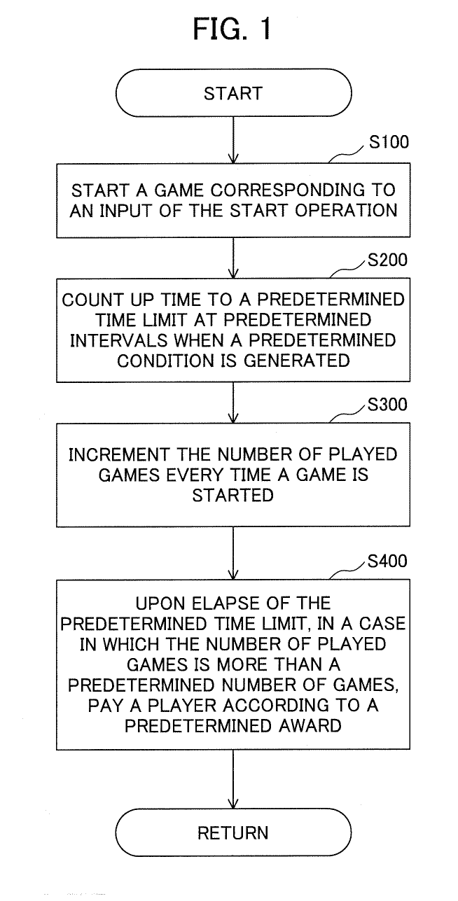

Specifically, as shown in FIG. 1, the CPU 106 CPU 106 starts the game in response to the acceptance of the input by the start operation in the game by way of a start switch 25 (Step S100). When a predetermined condition is generated, the CPU 106 starts processing for counting a predetermined time limit at a predetermined time interval (Step S200). Then, the CPU 106 starts processing for incrementing by a certain number the number of the played games every time the game is started (Step S300). Upon the predetermined time limit elapsing, in a case in which the number of the played games is more than the predetermined times of the games thus played, the CPU 106 provides an award according to a predetermined award (Step S400).

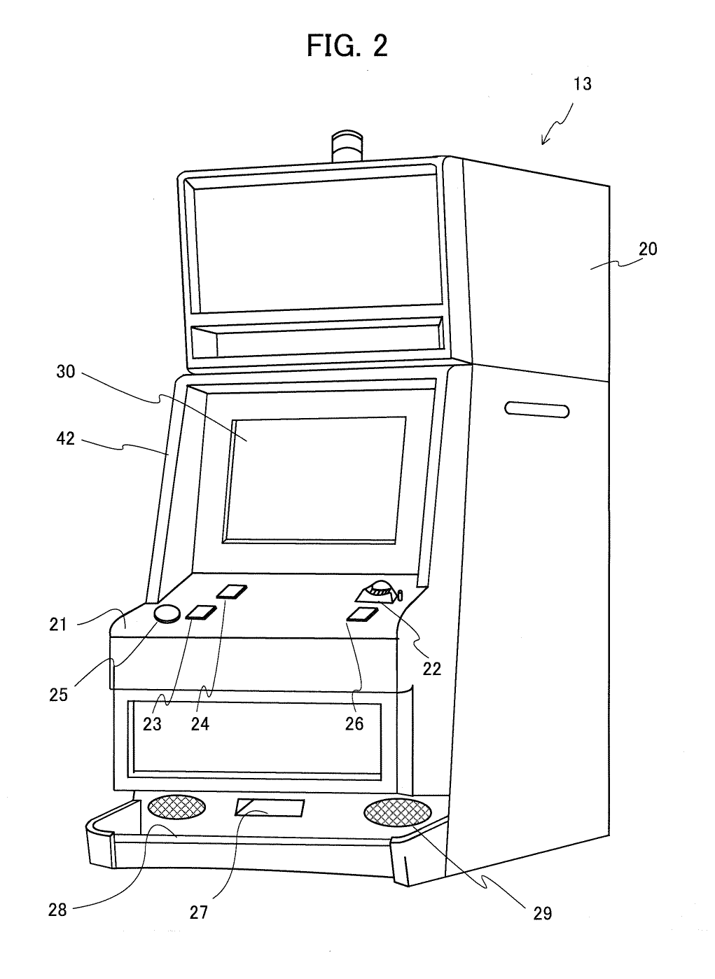

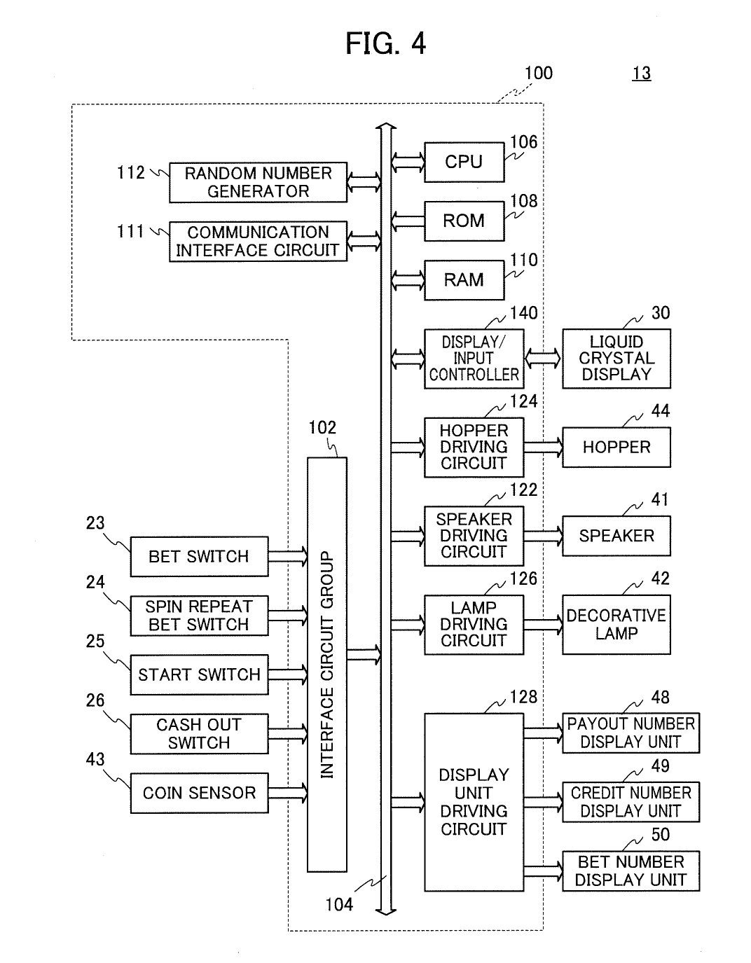

FIG. 2 is a perspective diagram illustrating the slot machine 13 according to the embodiment of the present invention. The slot machine 13 includes a cabinet 20 and a main door 42. The cabinet 20 has a structure in which the face facing the player is open. The cabinet 20 includes various kinds of components. Such components include: a controller 100 (see FIG. 4) for electrically controlling the slot machine 13; a hopper 44 for controlling insertion, retaining, and paying out of coins (game medium) (see FIG. 4), etc. The game medium is not restricted to coins. Furthermore, examples of such game media include medals, tokens, electronic money or electronic value information (credit) having the same value.

The main door 42 is a member that serves as a cover of the cabinet 20, which protects the internal components stored in the cabinet 20 from being exposed to the outside. The main door 42 includes the liquid crystal display 30 at approximately the center thereof.

The liquid crystal display 30 is provided for displaying various kinds of images with respect to the game such as images for providing visual effects. Such an arrangement allows the player to advance the game while visually confirming various kinds of images displayed on the liquid crystal display 30. The liquid crystal display 30 includes a transparent liquid crystal panel 34. The transparent liquid crystal panel 34 has a function of switching a part of or the entire area of the liquid crystal panel 34 between a transparent mode and an opaque mode, and a function of displaying various kinds of images.

In a configuration in which the slot machine 13 includes video reels, five virtual reels are displayed on the liquid crystal display 30. Note that the term “video reel” as used here represents a mechanism for displaying a reel on the liquid crystal display 30 in the form of an image. Multiple kinds of symbols necessary for the basic game include “BONUS”, “WILD”, “TREASURE BOX”, “GOLDEN MASK”, “HOLY CUP”, “COMPASS & MAP”, “SNAKE”, “A”, “K”, “Q”, “J”, and “10”. With such an arrangement, the liquid crystal display 30 displays these symbols with an image as if the reel were rotating.

The slot machine 13 includes an approximately horizontal operation unit 21 below the liquid crystal display 30. Furthermore, a coin insertion opening 22 is provided on the right side of the operation unit 21, which allows the player to insert coins. On the other hand, the components provided to the left side of the operation unit 21 include: a bet switch 23 which allows the player to determine which lines are to be set to active pay lines among nine lines L1, L2, L3, L4, L5, L6, L7, L8, and L9, for providing an award described later (which will simply be referred to as “active pay lines” hereafter), and which allows the player to select the number of coins as game media which are to be bet on the active pay lines; a spin repeat bet switch 24 which allows the player to play the game again without changing the number of coins bet on the active pay lines from that in the immediately prior game. Such an arrangement allows the player to set the number of coins bet on the active pay lines by performing a pressing operation on either the bet switch 23 or the spin repeat bet switch 24.

With the operation unit 21, a start switch 25 is provided on the left side of the bet switch 23, which allows the player to input a start operation instruction for the basic game in increments of games. Upon performing a pressing operation on either the start switch 25 or the spin repeat bet switch 24, which serves as a trigger to start the game, the five mechanical reels 3A to 3E start to rotate.

On the other hand, a cash out switch 26 is provided near the coin insertion opening 22. Upon the player pressing the cash out switch 26, the inserted coins are paid out from a coin payout opening 27 provided at a lower portion of the front face of the main door 42. The coins thus paid out are retained in a coin tray 28. Furthermore, the coin payout opening 27 is provided on the upper side of the coin tray 28, with sound transmission openings 29 provided to both the left and right of the coin payout opening 27. Here, the sound transmission openings 29 are provided for transmitting sound effects generated by a speaker 41 (see FIG. 4) stored within the cabinet 20.

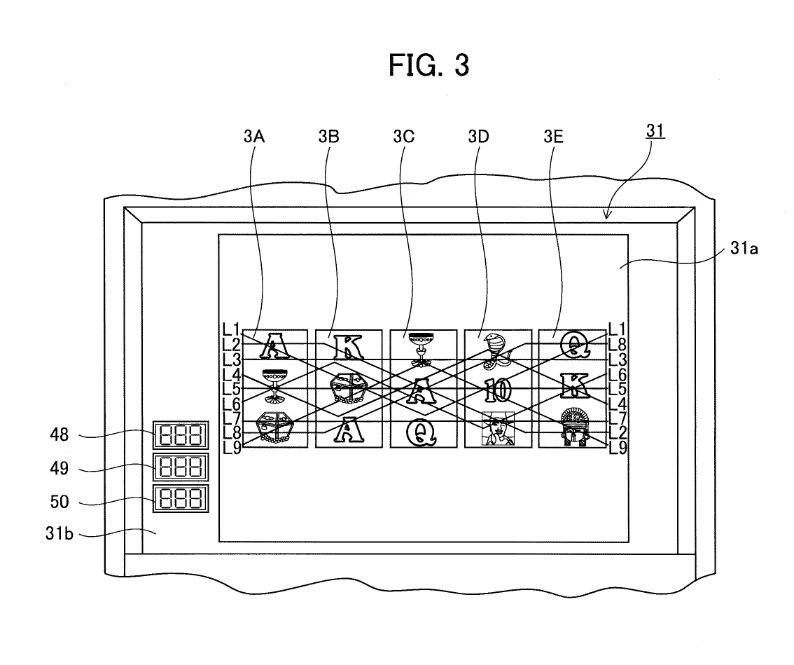

FIG. 3 is an enlarged view illustrating the display region of the slot machine 13. The liquid crystal display 30 of the slot machine 13 includes a front panel 31 and the transparent liquid crystal panel 34 provided to the rear face of the front panel 31. The front panel 31 comprises a transparent display screen 31a and a design formation area 31b where designs have been formed. Such an arrangement allows the player to visually confirm the image information displayed on the transparent liquid crystal panel 34 provided to the rear face of the front panel 31 through the display screen 31a of the front face 31. On the other hand, let us consider an arrangement in which the slot machine 13 comprises video reels. With such an arrangement, the transparent liquid crystal panel 34 in an opaque state may display the reels in the form of an image. Furthermore, an ordinary liquid crystal panel may be employed instead of the transparent liquid crystal panel 34.

Furthermore, various kinds of display units, i.e., a payout display unit 48, a credit amount display unit 49, and a bet amount display unit 50, are provided on the left side of the rear face the liquid crystal display 30. Note that the design formation area 31b of the front panel 31 is formed having a transparent portion that covers the top faces of these display units 48 through 50, thereby allowing the player to visually confirm the contents displayed on the display units 48 through 50.

The slot machine 13 has the nine lines L1 through L9 for providing awards as shown in FIG. 3. Each of the lines L1 through L9 for providing awards is formed such that it extends so as to pass through one of the symbols for each of the mechanical reels 3A to 3E when the five video reels have stopped.

Upon pressing the bet switch 23 once, the line L3 for providing a third award, the line L5 for providing a fifth award, and the line L7 for providing a seventh award, are set to be active pay lines, and one coin is input as a credit medal, for example.

Furthermore, upon pressing the bet switch 23 twice, the line L1 for providing a first award, the line L4 for providing a fourth award, and the line L8 for providing an eighth award, are set to be active pay lines, in addition to the three lines, and two coins are input as credit medals, for example.

Furthermore, upon pressing the bet switch 23 three times, the line L2 for providing a second award, the line L6 for providing a sixth award, and the line L9 for providing a ninth award, are set to be active pay lines, in addition to the six lines, and three coins are input as credit medals, for example.

The payout display unit 48 is a component for displaying the amount of the coins paid out when a combination of the symbols has been established along any one of the active lines for providing an award. The credit amount display unit 49 is a component for displaying the amount of the coins retained in the slot machine 13 in the form of a credit. The bet amount display unit 50 is a component for displaying the bet amount which is the number of coins bet on the active pay lines. Each of the display units 48 through 50 comprises a segment display device. Alternatively, each of the display units 48 through 50 may be displayed on the transparent liquid crystal panel 34 in the form of an image.

FIG. 4 is a block diagram illustrating an electric constitution of the controller 100 of the slot machine 13 having video reels. As shown in FIG. 4, the controller 100 of the slot machine 13 is a micro computer, and includes an interface circuit group 102, an input/output bus 104, the CPU 106, ROM 108, RAM 110, a communication interface circuit 111, a random number generator 112, a speaker driving circuit 122, a hopper driving circuit 124, a display unit driving circuit 128, and a display/input controller 140.

The interface circuits 102 are electrically connected with the input/output bus 104, which carries out input and output of data signals and address signals for the CPU 106.

The start switch 25 is electrically connected with the interface circuits 102. In the interface circuits 102, a start signal generated by the start switch 25 is transformed into a predetermined form of signal to be supplied to the input/output bus 104.

Furthermore, the bet switch 23, the spin repeat bet switch 24, and the cash out switch 26 are connected to the interface circuit group 102. In the interface circuits 102, a switching signal generated by each of these switches 23, 24 and 25 is transformed into a predetermined form of signal to be supplied to the input/output bus 104.

A coin sensor 43 is also electrically connected with the interface circuits 102. The coin sensor 43 detects coins inserted into the coin insertion slot 22, and is disposed at an appropriate position relative to the coin insertion slot 22. In the interface circuits 102, a sensing signal generated by the coin sensor 43 is transformed into a predetermined form of signal to be supplied to the input/output bus 104.

The ROM 108 and the RAM 110 are connected to the input/output bus 104.

Upon reception of the basic game start operation instruction input through the start switch 25, which serves as a trigger, the CPU 106 reads out a basic game program, and executes the basic game. The basic game program has been programmed so as to instruct the CPU 106 to perform the following operation. That is to say, according to the basic game program, the CPU 106 displays an image of the five video reels commencing to scroll the symbols on the five video reels on the liquid crystal display 30 via the display/input controller 140. Then, the CPU 106 displays an image of the five video reels stopping such that the combination of the symbols on these five video reels is rearranged, whereupon a new combination of the symbols is made along the active pay lines. In a case that a specified combination of the stationary symbols for providing an award has been made along any one of the active pay lines, the CPU 106 pays out a predetermined amount of coins corresponding to the specified combination for providing the award.

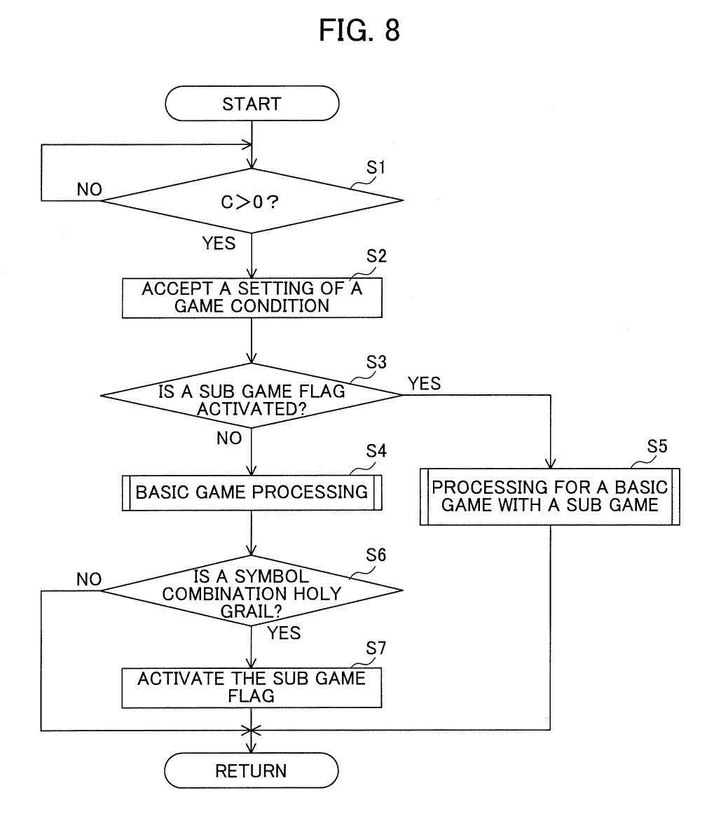

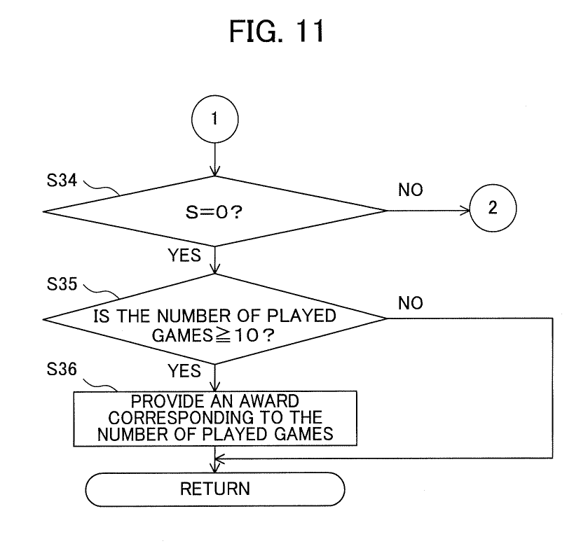

The ROM 108 stores: a control program for central control of the slot machine 13; a program for executing a routine shown in FIG. 8 and FIG. 11 (which is referred to as the “routine execution program” hereafter); initial data for executing the control program; and various data tables used for determination processing. Note that the routine execution program includes the basic game program etc. The RAM 110 temporarily stores flags, variables, etc., used for the control program.

Furthermore, a communication interface circuit 111 is connected to the input/output bus 104. The communication interface circuit 111 is a circuit for communicating with a server, etc., via various kinds of communication networks including a public telephone line network, LAN, etc.

Furthermore, the random number generator 112 for generating a random number is connected to the input/output bus 104. The random number generator 112 generates a random number in a predetermined range, e.g., in a range of 0 and 65535 (the sixteenth power of two minus one). Alternatively, an arrangement may be made in which the CPU 106 generates a random number by computation.

Furthermore, the display unit driving circuit 128 for driving each of the display units 48 through 50 is connected to the input/output bus 104. The CPU 106 controls the operation of each of the display units 48 through 50 via the display unit driving circuit 128 according to occurrence of a predetermined event.

The speaker drive circuit 122 for the speakers 41 is also electrically connected with the input/output bus 104. The CPU 106 reads out the sound data stored in the ROM 108, and transmits the sound data thus read to the speaker driving circuit 122 via the input/output bus 104. In this way, the speakers 41 generate predetermined sound effects.

The hopper drive circuit 124 for driving the hopper 44 is also electrically connected with the input/output bus 104. Upon reception of a cash out signal input from the cash out switch 26, the CPU 106 transmits a driving signal to the hopper driving circuit 124 via the input/output bus 104. Accordingly, the hopper 44 pays out coins such that the number of them is equivalent to the current number of coins remaining as credit, which is stored in a predetermined memory area of RAM 110.

Furthermore, the display/input controller 140 is connected to the input/output controller 140. The CPU 106 creates an image display command corresponding to the state and results of the game, and outputs the image display command thus created to the display/input controller 140 via the input/output bus 104. Upon reception of the image display command input from the CPU 106, the display/input controller 140 creates a driving signal for driving the liquid crystal display 30 according to the image display command thus input, and outputs the driving signal thus created to the liquid crystal display 30. As a result, a predetermined image is displayed on the transparent liquid crystal panel 34 of the liquid crystal display 30. The display/input controller 140 transmits the signal input through the touch panel 32 provided on the liquid crystal display 30 to the CPU 106 via the input/output bus 104 in the form of an input signal.

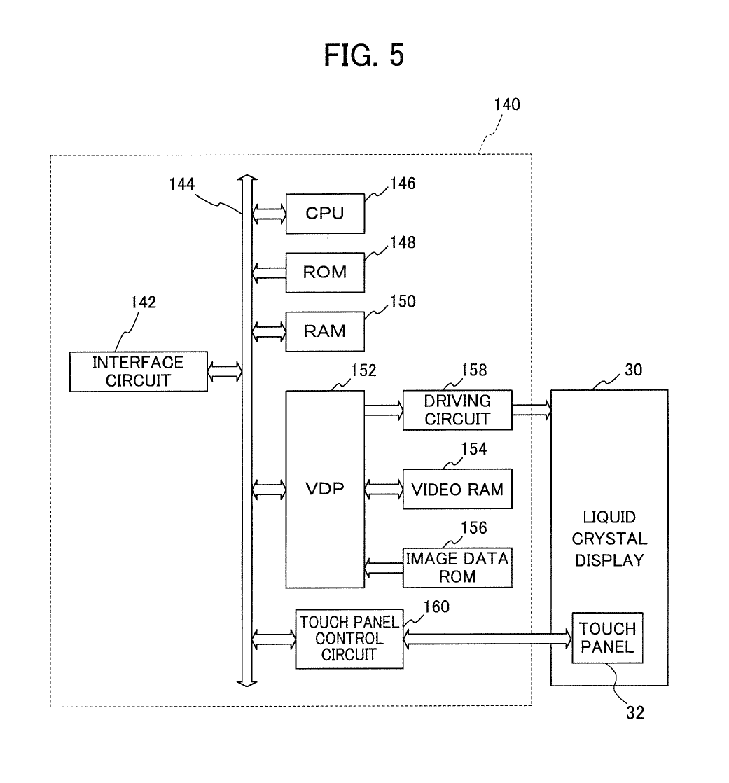

FIG. 5 is a block diagram illustrating the electric constitution of display/input controller 140 of the slot machine 13. The display/input controller 140 of the slot machine 13 is a sub-microcomputer for performing image display processing and input control for the touch panel 32. The display/input controller 140 comprises an interface circuit 142, an input/output bus 144, the CPU 146, ROM 148, RAM 150, a VDP 152, video RAM 154, image data ROM 156, a driving circuit 158, and a touch panel control circuit 160.

The interface circuit 142 is connected to the input/output bus 144. The image display command output from the CPU 106 of the controller 100 is supplied to the input/output bus 144 via the interface circuit 142. The input/output bus 144 performs input/output of data signals or address signals to/from the CPU 146.

Furthermore, the ROM 148 and the RAM 150 are connected to the input/output bus 144. The ROM 148 stores a display control program for generating a driving signal, which is to be supplied to the liquid crystal display 30, according to an image display command received from the CPU 106 of the controller 100. On the other hand, the RAM 150 stores flags and variables used in the display control program.

Furthermore, the VDP 152 is connected to the input/output bus 144. The VDP 152 includes a so-called sprite circuit, a screen circuit, a palette circuit, etc, and can perform various kinds of processing for displaying images on the liquid crystal display 30. With such an arrangement, the components connected to the VDP 152 include: the video RAM 154 for storing image data according to the image display command received from the CPU 106 of the controller 100; and the image data ROM 156 for storing various kinds of image data including the image data for visual effects etc. Furthermore, the driving circuit 158 for outputting a driving signal for driving the liquid crystal display 30 is connected to the VDP 152.

The CPU 146 instructs the video RAM 154 to store the image data which is to be displayed on the liquid crystal display 30 according to the image display command received from the CPU 106 of the controller 100 by reading out the display control program stored in the ROM 148 and by executing the program thus read. Examples of the image display commands include various kinds of image display commands including the image display commands for visual effects etc.

The image data ROM 156 stores various kinds of image data including the image data for visual effects etc.

The touch panel control circuit 160 transmits the signals input via the touch panel 32 provided on the liquid crystal display 30 to the CPU 106 via the input/output bus 144 in the form of an input signal.

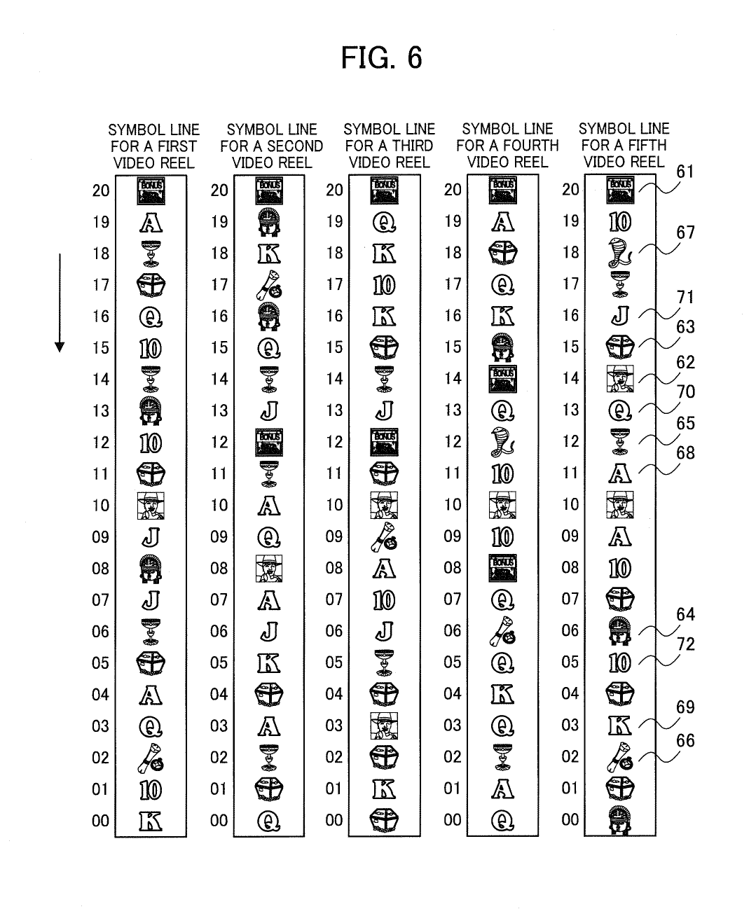

FIG. 6 shows symbol lines on which 21 symbols arranged on each video reel 3A to 3E are represented. The symbol line for the first video reel corresponds to the video reel 3A. The symbol line for the second video reel corresponds to the video reel 3B. The symbol line for the third video reel corresponds to the video reel 3C. The symbol line for the fourth video reel corresponds to the video reel 3D. The symbol line for the fifth video reel corresponds to the video reel 3E.

Referring to FIG. 6, a code number of “00” to “20” is assigned to for each symbol of video reels 3A to 3E. The code number is converted to be data in a data table so as to be stored in the ROM 108 (FIG. 4).

On each video reel 3A to 3E, a symbol line is represented with symbols as follows: Bonus symbol (symbol 61) (hereafter, “Bonus”), Wild symbol (symbol 62) (hereafter, “Wild”), Treasure Chest symbol (symbol 63) (hereafter, “Treasure Chest”), Golden Mask symbol (symbol 64) (hereafter, “Golden Mask”), Holy Grail symbol (symbol 65) (hereafter, “Holy Grail”), Compass and Map symbol (symbol 66) (hereafter, “Compasses and Map”), Snake symbol (symbol 67) (hereafter, “Snake”), Ace symbol (symbol 68) (hereafter, “Ace”), King symbol (symbol 69) (hereafter, “King”), Queen symbol (symbol 70) (hereafter, “Queen”), Jack symbol (symbol 71) (hereafter, “Jack”), and 10 symbol (symbol 72) (hereafter, “10”). The symbol line of each video reel 3A to 3E displays an image moving to the direction of the arrow in FIG. 8 (moving below from the top) by displaying an image that the each video reel 3A to 3E is being moved in forward direction.

Here in the present embodiment, each combination of “Bonus”, “Wild”, “Snake”, “Treasure Chest”, “Golden Mask”, “Holy Grail”, “Compass and Map”, “Ace”, “King”, “Queen”, “Jack” and “10” is set as an award combination. A combination (combination data) is control information which relates credits awarded to a player (the amount of payout of coins) to a combination of an award combination, and which is used for stop control of each video reel 3A through 3E, change (shift) of a game state, awarding of coins, and the like.

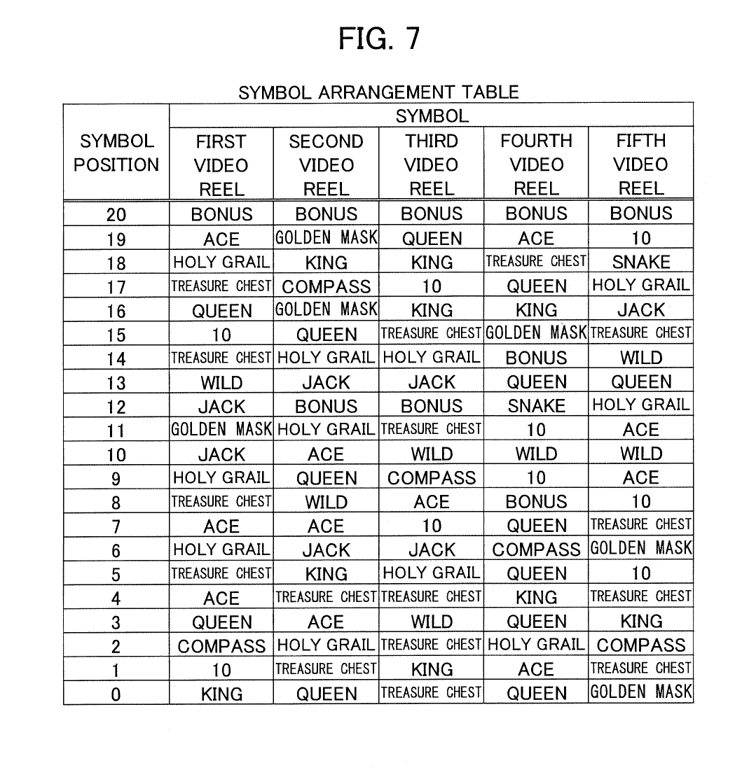

FIG. 7 shows a symbol arrangement table. The symbol arrangement table relates the code number indicating the position of each symbol which constitutes the symbol lines to each symbol of the respective video reels 3A to 3E, and then, registers thereof. In addition, the first video reel through the fifth video reel corresponds to the video reels 3A to 3E, respectively. In other words, the symbol arrangement table includes symbol information corresponding to the symbol position (the code number) of video reels 3A to 3E.

FIG. 8 is a flow chart illustrating a flow of the processing operation in the game machine 13 executed by the controller 100 of the game machine 13. The processing operation is called from a main program for the slot machine 13 at a predetermined timing, and then executed.

A description is provided below regarding a case in which the slot machine 13 has been activated beforehand. Furthermore, let us say that the variables used by the CPU 106 included in the controller 100 have been initialized to predetermined values, thereby operating the slot machine 13 in a normal state.

As shown in FIG. 6, the CPU 106 included in the controller 100 firstly determines whether or not any coins inserted by the player are remaining in a main flow of the game program executed in the gaming machine 13 (Step S1). More specifically, the CPU 106 reads an amount of credits C stored in RAM 110 and executes processes according to the amount of credits C thus read. When the amount of credits C equals “0” (NO in Step S1), the CPU 106 terminates the routine without executing any process, because it cannot start a game. When the amount of credits C is not less than “1” (YES in Step S1), the CPU 106 determines that coins remain as credit, and moves the process to Step S2.

The term “coin” refers to a game credit in the gaming machine. The credit may be currency circulated in the country where the present invention can be carried out. For example, the credit may also be medals that are uniquely used in the game hall where the present invention can be carried out and that are available to players by exchanging with currency in that country. Furthermore, the credits may be electromagnetic or electric information which can be stored in a storage medium such as a magnetic medium, an optical medium, or the like. In the case of electric information, the coin is stored in the storage medium as an award with values corresponding to the amount of the coins. In addition, “the coin” may be given to players by way of printed information such as a bar code, QR code, and the like, as well as being stored in the storage medium. In the present embodiment described below, although the coins as medals are paid out, it is selectable according to the way of payout employed in the gaming machine.

Upon advancing to Step S2, the CPU 106 sets a game condition, and moves the processing to Step S3. Specifically, the CPU 106 determines the number of coins bet in a basic game described later based on the number of the coins inserted by a player. Then, the CPU 106 receives an operational signal generated by a pressing operation of a bet switch 43. Based on the number of times the operational signal has been received, the CPU stores the bet amount in a predetermined memory area of the RAM 110. The CPU 106 reads the amount of credits C written in a predetermined area in the RAM 110. The CPU 106 subtracts a total bet amount including the abovementioned bet amount from the amount of credits C thus read. Then, the CPU 106 stores the subtracted value in a predetermined memory area in the RAM 110.

In Step S3, the CPU 106 determines whether or not a sub game flag is activated (described hereafter). More specifically, the CPU 106 refers to the flag which is stored in a predetermined area of the RAM 110, and determines whether it is activated or not. If it is activated (YES determination in the Step S3 processing), the CPU 106 moves the processing to Step S5. If it is not activated (NO determination in Step S3 processing), the CPU 106 moves the processing to Step S4.

In the following Step S4, the CPU 106 performs basic game processing. When the basic game processing is terminated, the CPU 106 advances the process to Step S6.

Upon moving to Step S5, the CPU 106 performs processing of a basic game with the sub game described later. When the basic game with the sub game is finished, the CPU 106 terminates the routine.

In Step S6, the CPU 106 determines whether or not the symbol combination matches Holy Grail. Specifically, the CPU 106 determines whether the determined symbol combination is Holy Grail or not in the basic game. If it is Holy Grail (in the case of determination of “YES” in the processing in Step S6), the CPU 106 advances the processing to Step S7. On the other hand, if it is not Holy Grail (in the case of determination of “NO” in the processing in Step S6), the CPU 106 terminates the routine.

In Step S7, the CPU 106 activates the sub game flag. More specifically, the CPU 106 activates the sub game flag which is stored in a predetermined area of the RAM 110. Upon finishing the processing in Step S7, the CPU 106 terminates the routine.

A description is made regarding a basic game processing with reference to FIG. 8.

In the following Step S11, the CPU 106 determines whether or not the start switch 25 is activated. Based on the determination, the CPU 106 stands by as is until the player operates the start switch 25. Upon the player operating the start switch 25, and accordingly, upon receipt of an operation signal via the start switch 25 (in a case of “YES” in the determination processing denoted by Step S11), the CPU 106 determines that the start switch 25 has been operated, and accordingly, the CPU 106 moves the processing to Step S12.

Upon moving to Step S12, the CPU 106 performs processing for determining a symbol combination. A specific description is provided below regarding the combination determination processing.

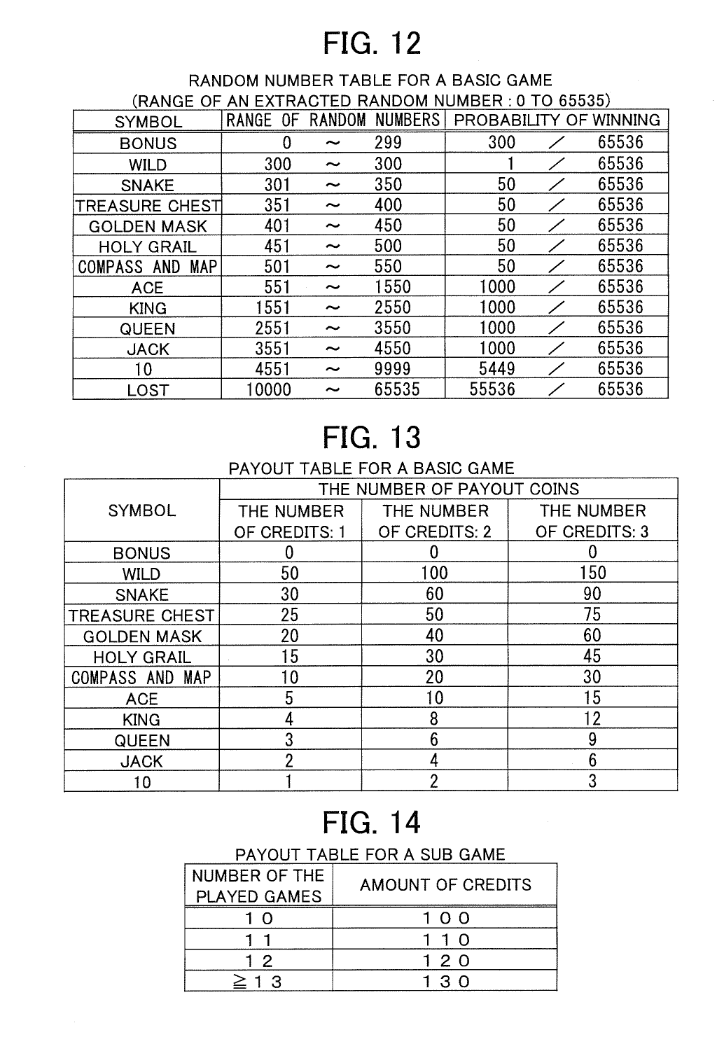

In the combination determination processing, first, the CPU 106 determines the combinations of the stationary symbols along the active pay lines. Specifically, the CPU 106 issues a command for the random number generator 112 to generate a random number, thereby extracting a random number in a predetermined range (in a range of “0” to “65535” in the present embodiment) generated by the random number generator 112. The CPU 106 stores the random number thus extracted in a predetermined memory area of the RAM 110. In this embodiment, the random number generator 112 displaced outside the CPU 106 generates random numbers. However, the present invention is not restricted to this setup. It may be alternatively possible that the CPU 106 generates random numbers without the random number generator 112. The CPU 106 reads a random number table for a basic game (see FIG. 12), and a payout table for a basic game (see FIG. 13), each of which is stored in the ROM 108. Then, the CPU 106 stores the random number table for a basic game and the payout table for a basic game thus read in a predetermined memory area of the RAM 110. It should be noted that the CPU 106 controls display of the stationary symbols for each reel based upon the random number table for a basic game. Furthermore, the CPU 106 reads the random number table for a basic game and the payout table for a basic game stored in the predetermined area of the RAM 110. Then, the CPU 106 determines the combination of the stationary symbols with respect to the active pay lines with reference to the random number table for a basic game, using the random number stored in the predetermined memory region of the RAM 110 as a parameter. Upon determination of specified combinations for providing an award, the CPU 106 stores the specified combination data for providing an award thus determined in a predetermined memory area of the RAM 110. Then, the CPU 106 reads out the random number and the specified combination data for providing an award stored in the predetermined memory area of the RAM 110, and determines the combination of the stationary symbols to be displayed based upon the random number and the specified combination data for providing an award thus read. In this stage, a symbol arrangement table (see FIG. 7) stored in the ROM 108 is read by the CPU 106. The symbol arrangement table thus read is stored in a predetermined memory area of the RAM 110, and used as reference data. The CPU 106 stores the data for the stationary symbols thus determined in a predetermined memory area of the RAM 110. Alternatively, an arrangement may be made in which the stationary symbols are determined for each reel using the random number table for a basic game.

Upon determination of the combination of the stationary symbols with respect to the active pay lines, the CPU 106 determines whether or not the combination of the stationary symbols with respect to the active pay lines matches any one of the specified combinations for providing an award. In a case that the stationary combination of the symbols with respect to the active pay lines matches any one of the specified combinations for providing an award, the CPU 106 activates a flag, which indicates that the player has won the award that corresponds to the kind of specified combination for providing an award, in order to provide the award that accords with the specified combination of symbols with respect to the active pay lines for providing the award. The activated flag, which indicates the player has won an award, is stored in a predetermined area of the RAM 110 according to the instruction from the CPU 106. On the other hand, in a case that the combination of the stationary symbols with respect to the active pay lines matches any one of the other combinations, i.e., the losing combinations, the CPU 106 does not activate the flag which indicates that the player has won an award. Subsequently, the CPU 106 moves the process to Step S6.

Here, a random number table for basic games shown in FIG. 12 is explained. In the random number table for a basic game, a range of random numbers and the probability of winning are registered in association with each of the specified winning combinations. In processing for determining a symbol combination, for example, in a case where a random number lying in a range of “0” to “299” is extracted from a range of numbers between “0” to “165535”, the internal component of the slot machine 13 determines to generate a bonus combination as the final results of the basic game. In other words, the probability is “300/65536” that the combination of the stationary symbols matches any one of the bonus combinations. On the other hand, in a case where a random number lying in a range of “10000” to “165535” is extracted from a range of numbers “0” to “65535”, the internal component of the slot machine 13 determines to generate other combinations, i.e. losing combinations, as the final results of the basic game. In other words, the probability is “55536/65536” that the combination of the stationary symbols matches any one of the losing combinations.

FIG. 13 shows a payout table for a basic game. In the payout table for a basic game, the coin amount to be paid out is registered in association with each specified combination for providing an award for each credit amount bet on one game. Therefore, let us consider a stage in which a determination is made whether the combination thus generated matches any one of the specified combinations for providing an award. In this stage, let us consider a case in which the combination thus generated matches the combination “Wild”. In this case, in a case where the credit amount bet is “1”, 50 coins are paid out. In a case where the credit amount bet is “2”, 100 coins are paid out. In a case where the credit amount bet is “3”, 150 coins are paid out.

Referring to Step S9 again, the CPU 106 instructs the video reels 3A through 3E to start to rotate. Specifically, the CPU 106 displays an image which shows rotating the video reels 3A to 3E, in sequence or Simultaneously, based upon the symbol arrangement table stored in the RAM 110.

Upon beginning to display a video image of the video reels 3A through 3E starting to rotate, the CPU 106 waits for a predetermined period of time to elapse (Step S14). After the predetermined period of time has elapsed (in a case of “YES” in the determination processing in Step S14), the CPU 106 instructs the video reels 3A through 3E to automatically stop rotating (Step S15). Specifically, the CPU 106 displays an image of the video reels 3A through 3E stopping to rotate in a predetermined order or at the same time such that the stationary symbols, which correspond to a specified winning combination as determined in the Step S12, is displayed in a display region that can be observed by the player. The CPU 106 then moves the processing to Step S16.

In the following Step S16, the CPU 106 determines whether a predetermined symbol combination has been formed based upon the results of the combination determination processing performed in Step S12. Specifically, the CPU 106 makes this determination based upon the state of the flag that indicates whether or not the player has won an award with respect to the active pay lines stored in the predetermined memory area of the RAM 110. In a case where the flag, which indicates that the player has won an award, has not been activated, i.e. in a case where the symbol combination matches a combination of “Others”, which is a combination other than the specified combinations for providing an award (in a case of NO in the determination processing in Step S10), the CPU 106 determines that the specified combination for providing an award has not been formed, and ends this routine. On the other hand, in a case where the flag, which indicates that the player has won an award, has been activated, i.e. in a case where the symbol combination matches any one of the combinations other than the combination of “Others” (in a case of YES in the determination processing in Step S10), the flow proceeds to Step 11 according to the instruction from the CPU 106.

In the following Step S17, the CPU 106 determines whether the symbol combination thus formed based upon the combination determination processing performed in Step S12 is a bonus combination. Specifically, the CPU 106 makes this determination based upon the state of the flag that indicates whether or not the player has won an award with respect to the active pay lines stored in the predetermined memory area of the RAM 110. In a case where the flag, which indicates that the player has won an award, has been activated, and the specified combination for providing an award is a “bonus” combination, the flow proceeds to Step 18 according to the instruction from the CPU 106. If not, the flow proceeds to Step 19.

In the following Step S18, the CPU 106 performs bonus game processing. Upon finishing the processing in Step S11, the CPU 106 terminates the routine.

In a case where the flow has proceeded to Step S19, the CPU 106 pays out an amount of coins corresponding to the specified combination for providing an award. Specifically, the CPU 106 calculates the amount of coins to be paid out for the specified combination for providing an award, with reference to the payout table for a basic game (FIG. 17). The CPU 106 reads out the credit amount stored in the predetermined memory area of the RAM 110. Then, the CPU 106 calculates the sum total amount of coins to be paid out thus calculated and the credit amount thus read, and stores the sum thus calculated in a predetermined memory area of the RAM 110. Furthermore, the CPU 106 displays the sum thus stored on the credit amount display unit 49. Subsequently, the CPU 106 terminates the routine.

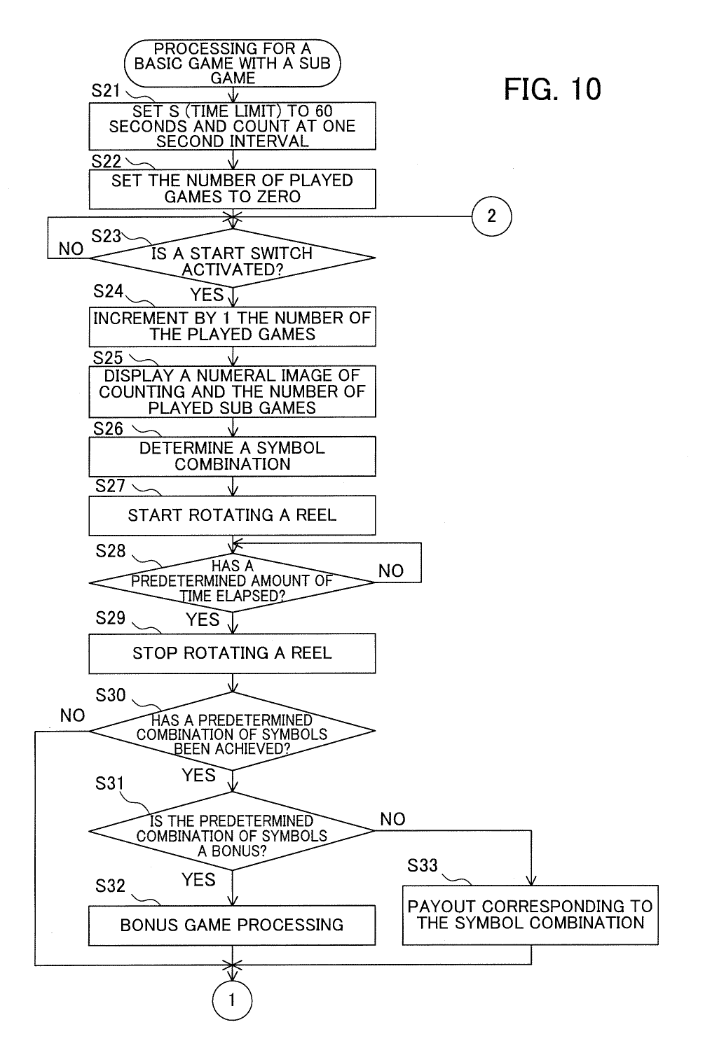

A description is provided regarding a basic game with sub game processing with reference to FIG. 10 and FIG. 11.

Firstly, in Step S21, the CPU 106 included in the controller 100 sets S as a time limit of the sub game to 60 seconds. Then, the CPU 106 performs counting at one second intervals, and moves the processing to Step S22. Specifically, the CPU 106 stores the value “60” as the time limit in a predetermined memory area in the RAM 110, and performs decrementing the value at one second intervals.

In Step S22, the CPU 106 initializes the number of sub games played to zero, and moves the processing to Step S23. More specifically, the CPU 106 stores the value of the number of games in a predetermined area of the RAM 110 and sets the value to zero.

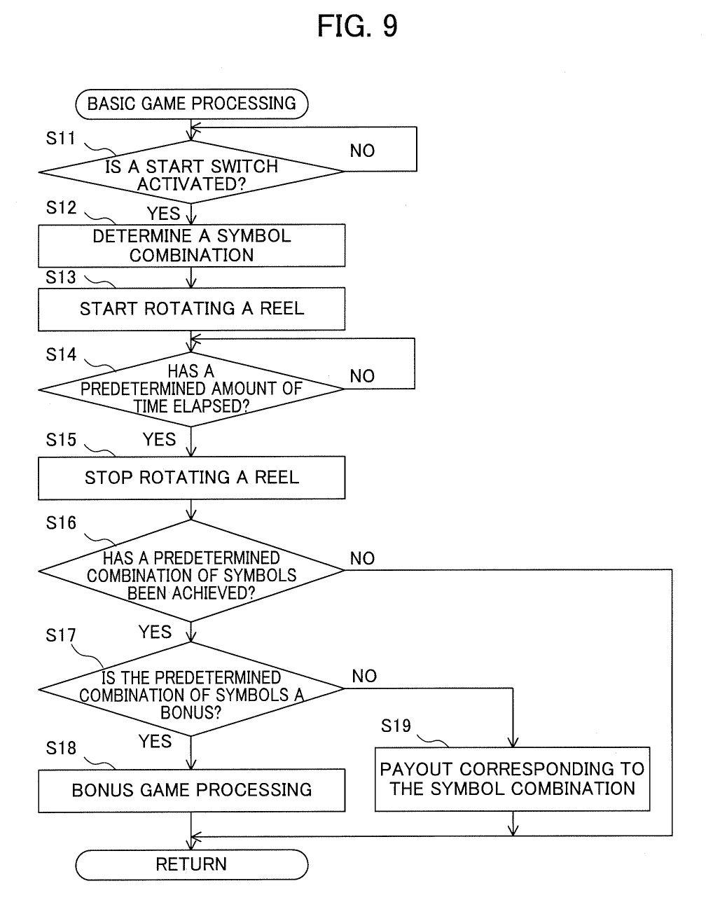

In Step S23, the CPU 106 decides whether the start switch is activated or not. If it is activated, the CPU 106 moves the processing to Step S24. If it is not activated, the CPU 106 moves the processing to Step S23. Specifically, this processing is the same as that in Step S11 described above with reference to FIG. 9.

Referring to FIG. 10 again, in Step S24, the CPU 106 increments by 1 the number of sub games played and the processing proceeds to Step S25. Specifically, the CPU 106 increments by 1 the number of sub games played stored in a predetermined memory area in the RAM 110.

In Step S25, the CPU 106 displays a numeral image in regards to processing for a counting time limit in S21 and the number of sub games played. Then, the CPU 106 moves the processing to Step S26. Specifically, the CPU 106 displays, on the liquid crystal display 30 via the display/input controller 140, a value of the time limit of the sub game during counting and a value of the number of sub games played, which are stored in a predetermined memory area in the RAM 110.

In Step S26, the CPU 106 performs processing for determining a symbol combination and then moves the processing to Step S27. Specifically, this processing is the same as that in Step S12 described above with reference to FIG. 9.

Referring to FIG. 10 again, in Step S27, the CPU 106 processes starting rotation of a scroll line, and moves the processing to Step S28. Specifically, this processing is the same as that in Step S13 described above with reference to FIG. 9.

Referring to FIG. 10 again, in Step S28, the CPU 106 determines whether a predetermined period of time has elapsed, and in a case where it has elapsed, the CPU 106 moves the processing to Step S29. When it has not elapsed, the CPU 106 moves the processing to Step S28. Specifically, this processing is the same as that in Step S14 described above with reference to FIG. 9.

Referring to FIG. 10 again, in Step S29, the CPU 106 processes stopping rotation of a scroll line, and moves the processing to Step S30. Specifically, this processing is the same as that in Step S15 described above with reference to FIG. 9.

Returning to FIG. 10, in Step S30, the CPU 106 determines whether or not a predetermined symbol combination has been formed. In a case that the predetermined symbol combination has been formed, the flow proceeds to Step S31. On the other hand, in a case that the predetermined symbol combination has not been formed, the flow proceeds to Step S34. Specifically, this processing is the same as that in Step S16 described above with reference to FIG. 9.

Returning to FIG. 10, in Step S31, the CPU 106 determines whether or not a symbol combination is a bonus. In a case that the symbol combination is a bonus, the flow proceeds to Step S32. On the other hand, in a case that the symbol combination is not a bonus, the flow proceeds to Step S33. Specifically, this processing is the same as that in Step S17 described above with reference to FIG. 9.

Referring to FIG. 10 again, in Step S32, the CPU 106 performs a bonus game processing, and moves the processing to Step S44. Specifically, this processing is the same as that in Step S18 described above with reference to FIG. 9.

Returning to FIG. 10, in Step S33, the CPU 106 performs payout processing according to the symbol combination, and the flow proceeds to Step S34. Specifically, this processing is the same as that in Step S19 described above with reference to FIG. 9.

Referring to FIG. 11, in Step S34, the CPU 106 determines whether S (a value of time limit) is zero or not. In a case where it is zero, the processing proceeds to Step S35. On the other hand, in a case where it is not zero, the processing proceeds to Step S23. Specifically, the CPU 106 refers to the value of the time limit of the sub game which is stored in a predetermined memory area in the RAM 106, during counting, and determines whether the value is zero or not.

In Step S35, the CPU 106 determines whether or not the number of sub games played is more than 10 times. When it is more than ten times, the processing is moved in Step S36, and when it is not more than 10 times, the CPU 106 terminates the routine. Specifically, the CPU 106 refers to the value of the number of sub games played, which is stored in a predetermined memory area in the RAM 106, and determines whether the value is more than ten times or not.

In Step S36, the CPU 106 provides an award corresponding to the number of games played. Specifically, the CPU 106 refers to the payout table for a sub game described later, and determines the amount of credits to be paid out. Upon finishing the processing in Step S36, the CPU 106 terminates the routine.

The payout table for a sub game shown in FIG. 14 is explained. The CPU 106 refers to the payout table for a sub game in order to determine the amount of credits corresponding to the value of the number of sub games played. For example, in the case where the number of sub games played is 11 times, the amount of credits is determined as “110”.

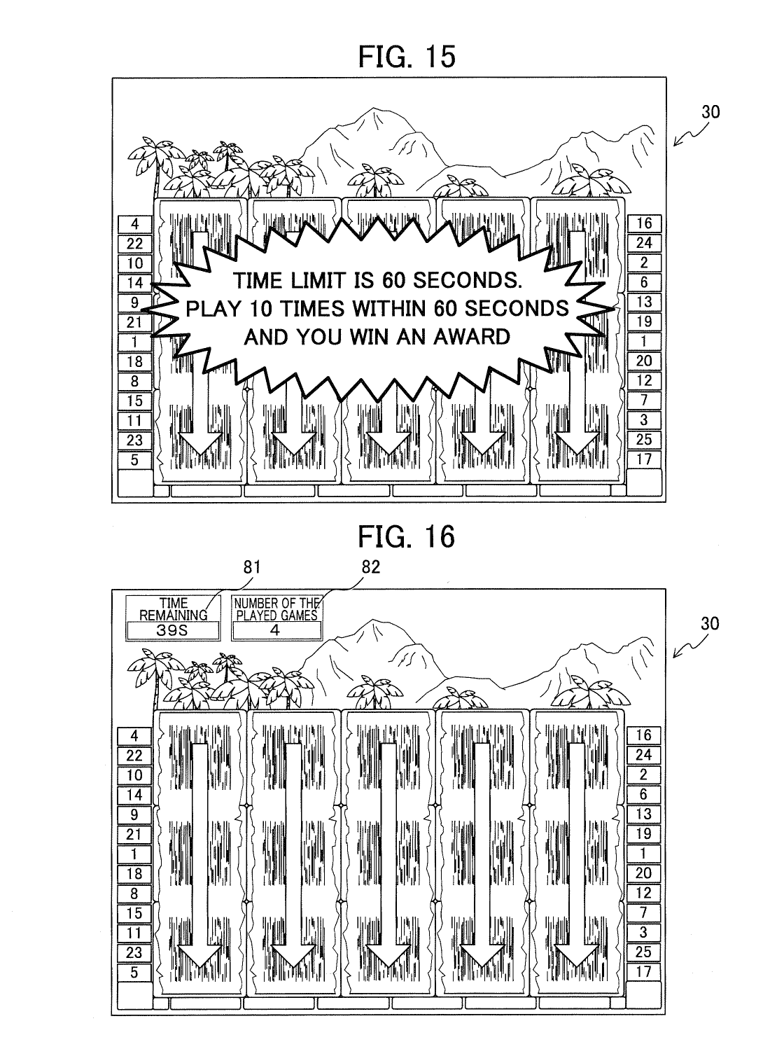

FIG. 15 is a diagram showing an example of a rendered image. In FIG. 15, upon a start of the basic game with the sub game in FIG. 10, the message “TIME LIMIT IS 60 SECONDS. PLAY 10 TIMES WITHIN 60 SECONDS AND YOU WIN AN AWARD” is displayed. The CPU 106 displays the image on the liquid crystal display 30 via the display/input controller 140.

FIG. 16 illustrates an example of the rendered image. According to FIG. 16, counting the time limit of the sub game and the number of sub games played in Step S25 in the FIG. 10 are displayed. Counting of the time limit is displayed on the display area 81 and the number of sub games played is displayed on the display area 82. The CPU 106 displays the image on the liquid crystal display 30 via the display/input controller 140.

It should be noted that although in the present embodiment the amount of credits corresponding to the number of sub games played is 100, 110, 120, and 130, the present embodiment is not limited thereto. Therefore, in the case where the number of sub games played is more than a predetermined number, the CPU may provide an award corresponding to a predetermined award.

In addition, although in the present embodiment the time limit of the sub game is 60 seconds, the present embodiment is not limited thereto. Another value may be used.

Furthermore, in the present embodiment, processing for counting the time limit of the sub game is not supposed to be stopped during counting. However, the present embodiment is not limited thereto. Therefore, in the case where a predetermined symbol combination is achieved, processing for counting the time limit of the sub game may be stopped during counting.

In addition, although in the present embodiment, an example applied to a video reel slot machine is explained regarding the present invention, the present embodiment is not limited thereto, and for example, the present invention may be applied to a mechanical slot machine.

Furthermore, although in the present embodiment, an example using a slot machine (a so-called casino machine) in which a reel is automatically stopped after being rotated without using a stop button is explained regarding the present invention, the present embodiment is not limited thereto, and for example, the present invention may be applied to a slot machine (a so-called Pachinko-slot machine) in which reels are stopped in the order by which a player stops the reels by hand using the stop button.

While the embodiments according to the present invention have been described as mentioned above, it is understood that many changes and modifications may be made therein without departing from the spirit and scope of the present invention.

What is claimed is:

1. A gaming machine, comprising:
a memory storing a number of played games and a predetermined time limit applied to the games;
an input device for accepting an operation to start a game; and
a controller configured with logic to:
(a) start the game when the input device has accepted the operation to start the game;
(b) start counting up time at predetermined regular intervals to the time limit when a result of the game satisfies a predetermined condition;
(c) increase the number of played games each time a game is started; and
(d) when the number of played games is equal to or greater than a predetermined threshold at expiration of the time limit, pay a player in accordance with a predetermined award.

2. The gaming machine according to claim 1,
further comprising a display device for displaying an image related to the game,
wherein the controller is further configured with logic to:
(e) cause the display device to display an image of the counted time.

3. The gaming machine according to claim 2,
wherein the controller is further configured with logic to:
(f) cause the display device to display an image of the number of played games.

4. A gaming machine, comprising:
a memory storing a number of played games and a predetermined time limit applied to the games;
an input device for accepting an operation to start a game; and
a controller configured with logic to:
(a) start the game when the input device has accepted the operation to start the game;
(b) start counting up time at predetermined regular intervals to the time limit when a result of the game satisfies a predetermined condition;
(c) increase the number of played games each time a game is started; and
(d) when the number of played games is equal to or greater than a predetermined threshold at expiration of the time limit, pay a player in accordance with the number of played games.

5. A gaming machine, comprising:
a display device for displaying an image related to a game;
a memory storing a number of played games and a predetermined time limit applied to the games;
an input device for accepting an operation to start a game; and
a controller configured with logic to:
(a) start the game when the input device has accepted the operation to start the game;
(b) start counting up time at predetermined regular intervals to the time limit when a result of the game satisfies a predetermined condition;
(c) increase the number of played games each time a game is started;
(d) cause the display device to display an image of the counted time; and
(e) when the number of played games is equal to or greater than a predetermined threshold at expiration of the time limit, pay a player in accordance with the number of played games.

6. The gaming machine according to claim 5,
wherein the controller is further configured with logic to (f) cause the display device to display an image of the number of played games.
